(19) United States
(12) Patent Application Publication
(10) Pub. No.: US 2025/0386203 A1
(43) Pub. Date: Dec. 18, 2025

(54) WIRELESS LOCAL AREA NETWORKS WITH CELLULAR BACKHAUL

(71) Applicant: DISH Wireless L.L.C., Littleton, CO (US)

(72) Inventor: In-Kyung Kim, Littleton, CO (US)

(21) Appl. No.: 18/746,322

(22) Filed: Jun. 18, 2024

(51) Int. Cl. H04W 16/14; H04W 76/10; H04W 92/20

(52) U.S. Cl. CPC H04W 16/14; H04W 76/10; H04W 92/20

(57) ABSTRACT

Various arrangements of a cellular network communication system and related methods are presented herein. A primary access point includes a cellular interface through which a cellular backhaul communication channel is established with a secondary access point. The secondary access point includes a cellular interface through which UE communicate, via the cellular network communication protocol, with the secondary access point and access the wired high speed network connection. The secondary access point further includes a cellular interface through which the cellular backhaul communication channel is established with the primary access point using the cellular network communication protocol.

### BACKGROUND

Typically, wireless location area networks (WLANs) utilize the Wi-Fi family of protocols that are based on the IEEE 802.11 family of standards to provide wireless network access over relatively short distances to devices. For example, in an office building or warehouse, a Wi-Fi based WLAN can be established that utilizes multiple access points (APs) to provide network access throughout the location.

Wi-Fi, however, can have drawbacks. For example, security and the ability to provide varying levels of service to different devices can be limited compared to other wireless communication protocols. Arrangements detailed herein address these and other drawbacks.

### SUMMARY

Various embodiments are described related to a cellular network communication system. In some embodiments, a cellular network communication system is described. The system may comprise a primary access point. The primary access point may comprise a wired high speed network connection. The primary access point may comprise a cellular interface through which a cellular backhaul communication channel may be established between a secondary access point and the primary access point using a cellular network communication protocol. The secondary access point may comprise a second cellular interface through which one or more user equipment (UE) communicate, via the cellular network communication protocol, with the secondary access point and access the wired high speed network connection via the cellular backhaul communication channel. The secondary access point may comprise a third cellular interface through which the cellular backhaul communication channel may be established with the primary access point using the cellular network communication protocol.

Embodiments of such a system may include one or more of the following features: the primary access point may further comprise a fourth cellular interface with which one or more additional UE communicate, via the cellular network communication protocol, with the primary access point and access the wired high speed network connection. The cellular network communication protocol may be 5G New Radio (NR). The secondary access point may provide gNodeB functionality to the one or more UE accessing the secondary access point using 5G NR. The secondary access point may use integrated access backhaul to communicate with the primary access point. The secondary access point may prioritize communications of the UE based upon slices to which the UE are assigned. A first frequency band may be used by the second cellular interface to communicate with UE and a second frequency band, wholly distinct from the first frequency band, may be used by the cellular interface and the third cellular interface for backhaul communications between the secondary access point and the primary access point. The secondary access point may further comprise a WiFi interface through which UE can communicate, via a WiFi communication protocol, with the secondary access point and access the Internet via the cellular backhaul communication channel. Communications received from the one or more UE via the WiFi interface of the secondary access point may be translated by the secondary access point for communication over the cellular backhaul communication channel with the primary access point. Communications received from the one or more UE via the WiFi interface of the secondary access point may be interspersed with communications received from one or more additional UE via the third cellular interface through the cellular network communication protocol according to a defined prioritization scheme. The system may further comprise a second secondary access point. The second secondary access point may comprise a fifth cellular interface through which one or more additional UE can communicate, via the cellular network communication protocol, with the second secondary access point and access the Internet via the cellular backhaul communication channel. The second secondary access point may comprise a sixth cellular interface through which the cellular backhaul communication channel may be established with the primary access point using the cellular network communication protocol. Accessing the Internet via the cellular backhaul communication channel may comprise performing voice over IP (VoIP) communications via the Internet. The secondary access point and the second secondary access point each may have no wired connection with any other access point. Each of the cellular interface, the second cellular interface, and the third cellular interface may use a multiple-input multiple-output (MIMO) communication arrangement.

In some embodiments, a method for using a cellular network communication system is described. The method may comprise receiving, by a secondary access point, first data from user equipment (UE) using cellular communications. The cellular network communication system may comprise a primary access point through which a wired high speed network connection may be accessed. The secondary access point may use a cellular backhaul communication channel established between the secondary access point and the primary access point using a cellular network communication protocol to access the wired high speed network connection. The method may comprise transmitting, by the secondary access point, via the cellular backhaul communication channel, the first data received by the secondary access point from the UE. The method may comprise receiving, by the primary access point, via the cellular backhaul communication channel, the first data from the secondary access point. The method may comprise transmitting, by the primary access point, via a wired network connection, the first data to a cellular network core.

Embodiments of such a method may include one or more of the following features: receiving, by the secondary access point, second data from a second UE using wireless local area network (WLAN) communications. The method may further comprise transmitting, by the secondary access point, via the cellular backhaul communication channel, the second data received by the secondary access point from the second UE. The method may further comprise receiving, by the primary access point, via the cellular backhaul communication channel, the second data from the secondary access point. The method may further comprise transmitting, by the primary access point, via the wired network connection, the second data to the Internet. The method may further comprise performing, by the secondary access point, prioritization among the first data received using the cellular communications and the second data received using the wireless local area network communications. A first frequency band may be used by the secondary access point to communicate with the UE and a second frequency band, wholly distinct from the first frequency band, may be used for cellular backhaul communications between the secondary access point and the primary access point. The method may further comprise performing, by the primary access point, prioritization among the first data received using the cellular communications, the second data received using the wireless local area network communications, and third data received directly by the primary access point from one or more additional UE. Receiving, by the primary access point, via the cellular backhaul communication channel, the data from the secondary access point may comprise the primary access point serving as a gNodeB for the secondary access point.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a system that performs backhaul between nodes using cellular communications.

FIG. 2 illustrates an embodiment of a system that performs backhaul between nodes using cellular communications and provides WLAN connectivity.

FIG. 3 illustrates a block diagram of a primary access point.

FIG. 4 illustrates a block diagram of a secondary access point.

FIG. 5 illustrates a block diagram of a platform from which a primary access point and a secondary access point can be created.

FIG. 6 illustrates an embodiment of a method for performing backhaul between nodes using cellular communications.

### DETAILED DESCRIPTION

In some environments, it can be preferrable to use a cellular communication standard for communication involving local devices. Conventionally, the Wi-Fi family of protocols can be used for wireless communications. However, there may be a desire for increased security and/or the ability to meet particular quality of service (QoS) and/or quality of experience (QoE) metrics. Therefore, alternatively or in addition to using Wi-Fi (or some other WLAN communication protocol), a cellular communication protocol can be used, such as 5G New Radio (NR). The use of a cellular communication protocol, such as 5G NR, can allow for increased security and the use of different slices to ensure that defined performance metrics are met for different user equipment (UE).

A primary access point (AP) is connected with a high speed network, through which the Internet and a cellular network core can be accessed. The primary AP can allow UE to communicate directly with the primary AP using a cellular communication standard (e.g., 5G NR) and, possibly, an additional wireless communication protocol, such as Wi-Fi. In order to extend the range of the primary AP, additional one or more APs, referred to as secondary APs, can be in communication with the primary AP. Each secondary AP does not have a direct connection to the high speed network or the cellular network core. Rather, each secondary AP relies on a wireless cellular backhaul connection with the primary AP.

From the perspective of the primary AP, each secondary AP is treated as a piece of UE. Accordingly, the primary AP serves as a gNodeB for each secondary AP. Each secondary AP functions as a gNodeB for UE wirelessly in communication with the secondary AP. Therefore, each secondary AP behaves as both UE (from the perspective of the primary AP) and as a gNodeB (from the perspective of UE). Additionally, in some embodiments, each secondary AP (and, possibly, the primary AP) can function as a WiFi access point. WiFi communication traffic is translated to 5G cellular communications for transmission via the backhaul communication channel to the primary AP. The primary AP can then translate and route the WiFi communications as necessary via the high speed network connection. From the perspective of UE, when connected with either a primary or secondary AP, the UE may be able to access all of the cellular services as if the UE as communicating with a base station operated by the cellular network operator.

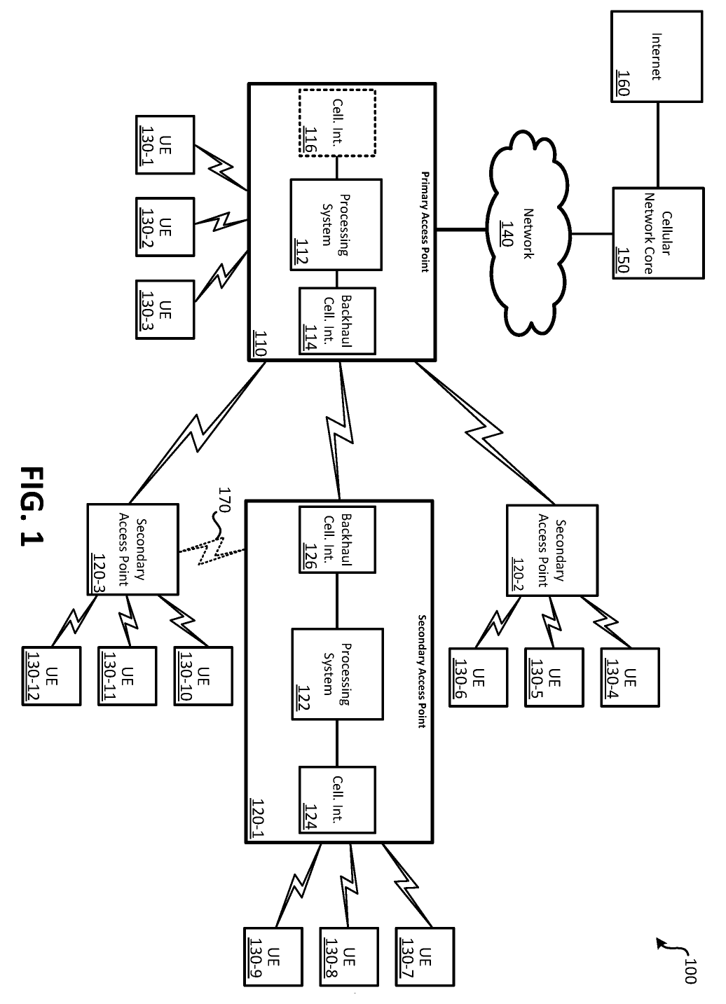

Further detail regarding these and additional aspects is provided in relation to the figures. FIG. 1 illustrates an embodiment of a cellular network communication system 100 (“system 100”) that performs backhaul between nodes using cellular communications. System 100 can include: primary access point (AP) 110; one or more secondary APs 120 (120-1, 120-2, 120-3); UE 130; network 140; cellular network core 150; and Internet 160. UE can be any form of computerized device that accesses either Internet 160 and/or cellular network core 150, such as smartphones, Internet of Things (IoT) devices, gaming devices, smart factory equipment, smart sensors, smart security equipment, computers, or local access points (e.g., hotspot devices) to which other devices can connect.

Primary AP 110 serves to communicate with one or more secondary APs 120 and interface with network 140. Primary AP 110 can use a wired connection to network 140. In some embodiments, this wired connection is a high-speed wired connection to an Internet Service Provider’s (ISP’s) network. For example, an optical fiber connection may be made to network 140. Via network 140, primary AP 110 can communicate with Internet 160 and cellular network core 150. Cellular network core 150 can be hosted on a public cloud computing service or may be operated on a privately managed server system. All cellular traffic with primary AP 110 and secondary APs 120 by UE 130 is routed to cellular network core 150. As needed, cellular network core 150 can access Internet 160, which can occur through one or more firewalls and can be performed by a user plane function (UPF) of cellular network core 150.

Cellular network core 150 can provide core cellular network functionality. Components of cellular network core 150 can include: network resource management components; policy management components; subscriber management components; and packet control components. Additionally, cellular communications that require accessing the Internet is performed via cellular network core 150.

More specifically, network resource management components can include: Network Repository Function (NRF) and Network Slice Selection Function (NSSF). The NRF can allow 5G network functions (NFs) to register and discover each other via a standards-based application programming interface (API). The NSSF can be used by the AMF to assist with the selection of a network slice that will serve a particular UE. Policy management components can include: a Charging Function (CHF) and a Policy Control Function (PCF). The CHF allows charging services to be offered to authorized network functions. Converged online and offline charging can be supported. The PCF allows for policy control functions and the related 5G signaling interfaces to be supported. Subscriber management components can include: a Unified Data Management (UDM) and Authentication Server Function (AUSF). The UDM can allow for generation of authentication vectors, user identification handling, NF registration management, and retrieval of UE individual subscription data for slice selection. The AUSF performs authentication with UEs. Packet control components can include: Access and Mobility Management Function (AMF) and Session Management Function (SMF). The AMF can receive connection- and session-related information from UEs and is responsible for handling connection and mobility management tasks. The SMF is responsible for interacting with the decoupled data plane, creating updating and removing Protocol Data Unit (PDU) sessions, and managing session context with the User Plane Function (UPF). The User plane function (UPF) can be responsible for packet routing and forwarding, packet inspection, quality of service (QoS) handling, and external PDU sessions for interconnecting with a Data Network (DN) (e.g., the Internet) or various access networks.

Primary AP 110 can: 1) communicate directly with user equipment (UE) via a cellular communication protocol (function as a gNodeB for UEs attached with it); and 2) communicate with the secondary APs via a cellular communication protocol (function as a gNodeB for the secondary APs by providing wireless backhaul connectivity to the second APs via the cellular communication protocol. Primary AP 110 can aggregate communications for all UE with cellular network core 150. In other embodiments, primary AP 110 may not communicate directly with UEs. As shown, three UE (130-1, 130-2, and 130-3) are in direct communication with primary AP 110 via a cellular communication protocol. The cellular communication protocol can be 5G New Radio (NR). Other cellular communication protocols can be used, such as 6G and beyond. From the perspective of UEs 130-1, 130-2, and 130-3, when 5G NR is used as the cellular communication protocol, primary AP 110 functions as the gNodeB. Therefore, distributed unit (DU) functionality, centralized unit (CU) functionality, and cellular network core access are provided via primary AP 110. As an example of DU functionality that is provided, scheduler functions are implemented locally to allow for the proper scheduling of communications with UE.

When a UE accesses primary AP 110 via the cellular communication protocol, the UE’s access may be made via a particular cellular network slice. Slicing can allow for particular radio, processing, and bandwidth resources to be reserved for a particular UE or group of UE. As such, different UE can be provided different quality of service (QoS) parameters by assigning the UE to different slices. Accordingly, a UE may be assigned to a slice depending on the importance and functionality of the UE.

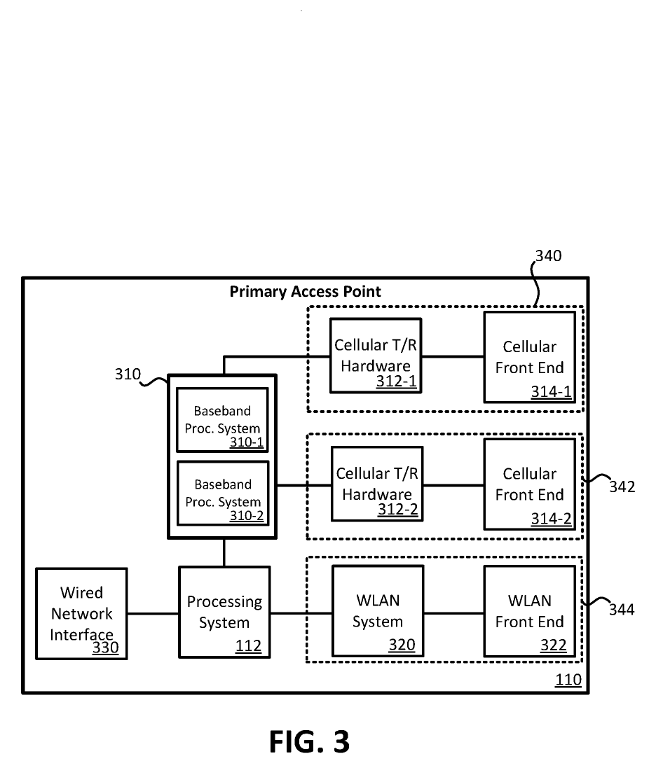

Primary AP 110 can include: processing system 112, backhaul cellular interface 114, and cellular interface 116. Cellular interface 116 may only be present if UE communicate directly with primary AP 110. Further details regarding cellular interface 116, backhaul cellular interface 114, and processing system 112 are provided in relation to FIG. 3. Primary AP 110 is shown in direct cellular communication with three UE (130-1, 130-2, 130-3); this is for example only. In other embodiments, fewer or greater numbers of UE may be in direct communication with primary AP 110.

Secondary APs 120 do not have a wired connection to network 140. Rather, secondary APs 120 rely on a cellular communication protocol backhaul link with primary AP 110 in order to access network 140. Three secondary APs 120 (120-1, 120-2, and 120-3) are shown by way of example; in other examples, fewer or greater numbers of secondary APs 120 may be present.

UE wirelessly communicate via a cellular communication protocol (e.g., 5G NR) with a secondary AP, such as secondary AP 120-1. From the perspective of UE (130-7, 130-8, 130-9), secondary AP 120-1 provides gNodeB functionality and access to network 140 (including cellular network core 150 and Internet 160). Secondary AP 120-1 functions as a gNodeB for these UE, but secondary AP 120-1 functions as a UE to primary AP 110. Secondary AP 120-1 can receive, transmit, and prioritize communications with UE 130-7, 130-8, and 130-9. UE communications can be prioritized (e.g., according to slices) and transmitted via a backhaul communication channel to primary AP 110. The backhaul communication channel also uses the cellular communication protocol. From the perspective of primary AP 110, secondary AP 120-1 behaves as a UE.

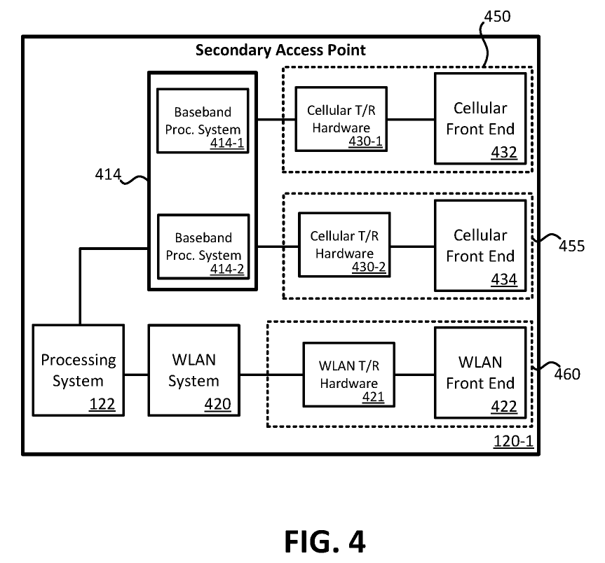

Secondary AP 120-1 can include: processing system 122, backhaul cellular interface 126; and cellular interface 124. Further details regarding cellular interface 124, backhaul cellular interface 126, and processing system 122 are provided in relation to FIG. 4. As shown, three UE (130-7, 130-8, and 130-9) are in communication with secondary AP 120-1; this is for example only. Fewer or a greater number of UE may access secondary AP 120-1 in order to access network 140.

As depicted in FIG. 1, a hub-and -spoke network topology may be used. In such a topology, each secondary AP (120-1, 120-2, and 120-3) has a direct cellular communication protocol backhaul to primary AP 110. In other embodiments, a mesh or daisy chain topology may be used in which a secondary AP communicates with another secondary AP, which in turn communicates with primary AP 110. For example, secondary AP 120-3 may communicate with secondary AP 120-1 (as indicated by cellular communication backhaul 170), which communicates with primary AP 110. Regardless of network topology, each of secondary APs 120 may be physically connected to only power with all communications performed wirelessly.

In FIG. 1, three secondary APs are illustrated. Fewer or greater numbers of secondary APs may be present in other embodiments. As shown, UE 130-4, 130-5 and 130-6 communicate with secondary access point 120-2. UE may move and thus may shift with which AP communication is performed, and, as disclosed for each other secondary AP, the number of UE communicating with secondary AP 120-2 can be greater or fewer than three.

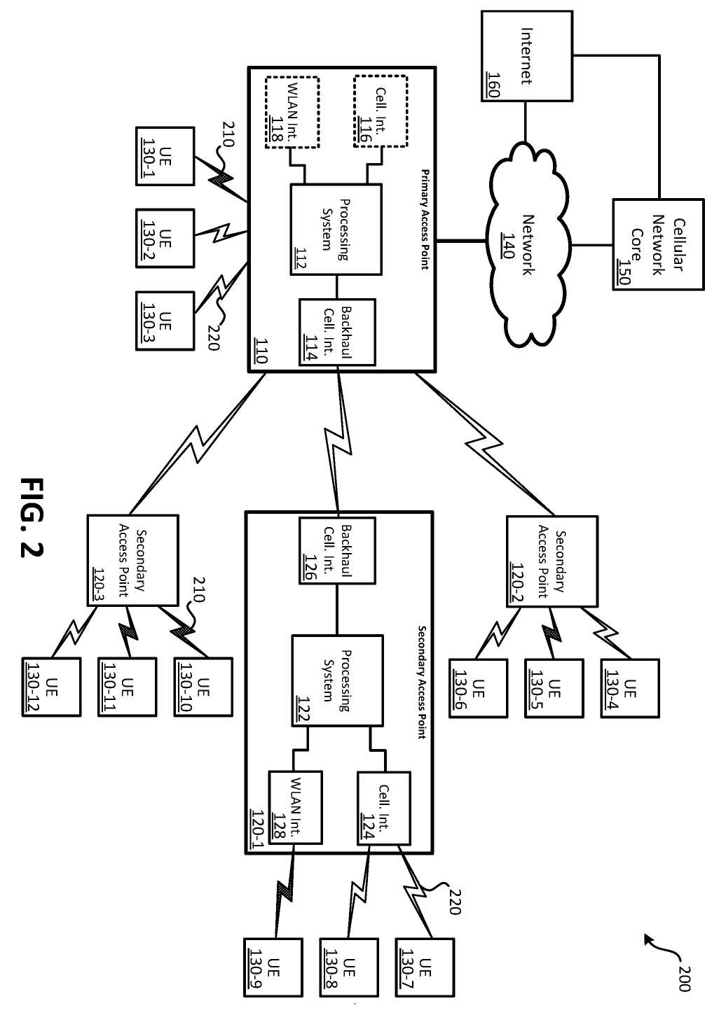

FIG. 2 illustrates an embodiment of a cellular network communication system (“System 200”) that performs backhaul between nodes using cellular communications and provides WLAN connectivity. System 200 functions similarly to system 100 with the addition of providing WLAN connectivity to UE. WLAN connectivity can be provided to UE via a Wi-Fi family protocol, which is based on the IEEE 802.11 family of standards. Therefore, a UE can use a WLAN connection, cellular connection, or both to communicate with primary AP 110 directly or a secondary AP, such as secondary AP 120-1.

WLAN communications performed by UE with a secondary AP are also transmitted to primary AP 110 via cellular backhaul communication. Secondary APs 120 can use a defined prioritization scheme to define how WLAN communications are prioritized in relation to cellular communications. For example, WLAN communications may be effectively treated as a slice in that particular QoS parameters are met, which may be higher or lower than some or all cellular slices.

Once WLAN communications are transmitted by the secondary AP (e.g., secondary AP 120-1) to primary AP 110, primary AP 110 may translate the communications to an appropriate protocol (e.g., TCP/IP) and transmit to network 140. WLAN communications can be routed directly to Internet 160 by primary AP 110 via network 140. In contrast, cellular communications by UE 130 via primary AP 110 and secondary APs 120 are routed to cellular network core 150, which handles communications with Internet 160. In other embodiments, WLAN communications involving the Internet can also be routed to cellular network core 150, which can then access Internet 160. IMS voice communications over the WLAN can be routed to cellular network core 150.

As shown in FIG. 2, some UE are using WLAN communications to access Internet 160, as shown by WLAN communications 210. Other UE are using cellular communications to access Internet 160 through cellular network core 150, as shown by cellular communications 220. UE may also use both forms of wireless communication. For example, a UE may be executing multiple applications: a first application may use cellular communication in order to ensure security and/or that particular QoS parameters are met (e.g., latency, uplink bandwidth, downlink bandwidth, jitter), and a second application may use WLAN communication since security and/or QoS are not as essential to the functioning of the second application.

As shown in FIG. 2, secondary AP 120-1 may have a WLAN interface 128. Further detail is provided in relation to FIG. 4. Primary AP 110 may have WLAN interface 118. In some embodiments, this interface is not present and primary AP 110 cannot perform direct WLAN communications with UE. Further detail regarding primary AP 110 is provided in relation to FIG. 3.

FIG. 3 illustrates a block diagram of a primary AP 110. Primary AP 110 can include: processing system 112; baseband processing system 310; cellular transmit and receive (T/R) hardware 312; cellular front ends 314; WLAN system 320; WLAN front end 322; and wired network interface 330.

Processing system 112 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as random access memory (RAM), flash memory, a hard disk drive (HDD), or a solid state drive (SSD).

Processing system 112 may handle interfacing with the cellular network core 150, through wired network interface 330, and providing management functions, including: routing the cellular traffic to cellular network core 150; routing WLAN traffic directly to the Internet; routing IMS voice (VoNR) to cellular network core 150; in some arrangements, routing all traffic (i.e., cellular and WLAN communications) to cellular network core 150; configuring and managing secondary APs; managing gNodeB to gNodeB interfacing; self-organizing network (SON) functionality; and spectrum management handling (e.g., spectrum access system (SAS) and automated frequency coordination (AFC) handling for unlicensed/shared spectrum management).

As depicted in FIG. 1, cellular interface 116 is present. Cellular interface 116 can include baseband processing system 310, cellular T/R hardware 312, and cellular front ends 314. Baseband processing system 310 may be a system on a chip (SOC) or multi-chip system that serves to perform cellular-specific computing. Baseband processing system 310 can perform baseband processing for RF unit 340 and RF unit 342, which is represented as baseband processing systems 310-1 and 310-2. Baseband processing system 310 can include a lower layer processing unit that utilizes special-purpose hardware acceleration (e.g., a purpose-designed ASIC). Baseband processing system 310 can also include an upper level processing unit that is implemented using one or more general purpose processors. Baseband processing system 310 can perform execution of algorithms that include channel estimation, modulation, demodulation, and forward error correction (FEC). Accordingly, baseband processing system 310 can translate data into and out of a digital form specific for transmission on a 5G NR network.

Processing system 112 may perform functionality including prioritization and gNodeB functionality. For example, processing system 112 may function as a DU and, possibly, provide CU functionality for UE wirelessly communicating with primary AP 110. As an example of DU functionality that is provided, scheduler functions are implemented locally to allow for the proper scheduling of communications with UE via RF unit 340. Processing system 112 can also perform communication prioritization, such as, according to the slice UE, are assigned to and according to whether the UE is using cellular or a WLAN communication protocol.

Cellular T/R hardware 312 serves to convert between digital data and RF. Digital data is received by cellular T/R hardware 312-1 and is output as RF to cellular front end 314-1. RF is received by cellular T/R hardware 312-1 from cellular front end 314-1 and converted to digital data for baseband processing system 310.

Cellular front ends 314 can include multiple amplifiers, mixers, and antennas used to transmit and receive RF. Cellular front end 314-1 can be used for a multiple input, multiple output (MIMO) arrangement allowing for multiple transmissions or multiple receptions of RF simultaneously. For example, cellular front end 314-1 can include four antennas and associated hardware. Cellular front end 314-1 can allow for a 4x4 transmit/receive arrangement on 100 MHz of bandwidth. Cellular front end 314-2 can include similar hardware.

As previously detailed, primary AP 110 may directly communicate with UE and may also have one or more cellular backhaul communication channels with one or more secondary APs. Separate hardware and/or spectrum may be used for each of these uses. For example, RF unit 340 may be used exclusively for communication with UE by providing gNodeB functionality to such UE, while RF unit 342 may be used exclusively for cellular backhaul communications with one or more secondary access points.

One key differentiator between WLAN communications and cellular is that cellular uses reserved spectrum that is licensed or permitted to a particular cellular network operator. Therefore, in order to perform cellular communications on particular frequency bands, the operator of primary AP 110 must obtain permission to use the spectrum, such as via the cellular network provider operating cellular network core 150. As an example, a cellular network provider may offer the use of primary AP 110 and secondary APs 120 as an additional service to its subscribers or partners. Spectrum licensed by the cellular network provider can then be used by the subscribers or partners as part of their service with the cellular network provider. In some embodiments, cellular communications can be performed using unlicensed spectrum. For example, Consumer Broadband Radio Service (CBRS) General Authorized Access (GAA), NR-U (NR unlicensed) using, for example, n96 (6 GHz spectrum) are possible options.

As an example, RF unit 340 may be assigned to use bands n77 (which includes CBRS), n48 for communication directly with UE, while RF unit 342 may be assigned to use bands n96 and/or n46 for cellular backhaul communications. In some embodiments, bands used for communication directly with UE are not also used for backhaul; in other embodiments, spectrum can be shared. For example, bands n96, and/or n46 may also be used for communication directly with UE. The specific spectrum used may be dependent on what spectrum the cellular network operator has a license to use. If primary AP 110 does not communicate with UE directly, RF unit 340 may not be present or may be used for cellular backhaul with secondary APs instead.

Primary AP 110 also includes wired network interface 330. Wired network interface 330 is connected with network 140, which can be operated by an internet service provider or as a private high-speed fiber network. Wired network interface 330 may connect to network 140 via one or more modems or routers.

Optionally present in primary AP 110 are WLAN components 344. WLAN components 344 include WLAN system 320 and WLAN front end 322. WLAN system 320 serves to convert between digital data and RF. WLAN front end 322 can include multiple amplifiers, mixers, and antennas used to transmit and receive RF. WLAN front end 322 can be used for a multiple input, multiple output (MIMO) arrangement allowing for multiple transmissions or multiple receptions of RF simultaneously. For example, WLAN front end 322 can include four antennas and associated hardware.

FIG. 4 illustrates a block diagram of a secondary access point. Secondary AP 120-1 is illustrated with other secondary APs being similar or identical in componentry. Secondary AP 120-1 can include: processing system 122; baseband processing system 414; cellular transmit and receive (T/R) hardware 430; cellular front end 432; cellular front end 434; WLAN system 420; and WLAN transmit and receive (T/R) hardware 421; and WLAN front end 422. Notably, no wired network connection may be present, hence wireless communication with primary AP 110 is required for functionality. Cellular interface 124 of FIGS. 1 and 2 can represent RF units 450 and 455 and baseband processing system 414.

Processing system 122 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as RAM, flash memory, an HDD, or an SSD. Processing system 122 may perform functionality including prioritization and gNodeB functionality. For example, processing system 122 may function as a DU and, possibly, provide CU functionality for UE wirelessly communicating with secondary AP 120-1. As an example of DU functionality that is provided, scheduler functions are implemented locally to allow for the proper scheduling of communications with UE. Processing system 122 can also perform communication prioritization, such as, according to the slice UE, are assigned to and according to whether the UE is using cellular or a WLAN communication protocol. Processing system 122 may also handle configuring and managing secondary APs; managing gNodeB to gNodeB interfacing; self-organizing network (SON) functionality; and spectrum management handling (e.g., spectrum access system (SAS) and automated frequency coordination (AFC) handling for unlicensed/shared spectrum management).

Processing system 122 can also manage cellular backhaul functionality by prioritizing and aggregating communications, including both cellular and WLAN communications. Cellular (and WLAN, if present) communications from UE are aggregated and convert for transmission via cellular backhaul communications implemented using RF unit 455. Conversion may be necessary such that the communications forwarded by secondary AP 120-1 to primary AP 110 are properly formatted as if secondary AP 120-1 is the UE and is using primary AP 110 as its gNodeB. While secondary AP 120-1 behaves as the gNodeB to the UE in direct cellular communication with secondary AP 120-1, primary AP 110-1 behaves as the gNodeB for secondary AP 120-1 (e.g., by providing scheduling services for cellular communications). Backhaul can be performed using Integrated Access/Backhaul, referred to as IAB. In IAB, an IAB Node (e.g., secondary AP) behaves as a UE communicating with an IAB Donor (e.g., primary AP). In accordance with IAB, the primary AP performs RACH and RRC signaling for radio resource allocation and authentication. A difference between the backhaul protocol and regular access link protocol used by UE is in the RLC layer.

RF units 450 and 455 include hardware necessary to communication with UE and primary AP 110, respectively. RF unit 450 can include cellular T/R hardware 430-1 and cellular front end 432. Cellular T/R hardware 430-1 serves to convert between digital data and RF. Digital data is received by cellular T/R hardware 430-1 and is output as RF to cellular front end 432. RF is received by cellular T/R hardware 430-1 from cellular front end 432 and converted to digital data for baseband processing system 414. RF unit 450 is used for cellular communications with one or more UE. Cellular front end 432 can include multiple amplifiers, mixers, and antennas used to transmit and receive RF. Cellular front end 432 can be used for a multiple input, multiple output (MIMO) arrangement allowing for multiple transmissions or multiple receptions of RF simultaneously. For example, cellular front end 432 can include four antennas and associated hardware. The components of RF unit 455, including cellular T/R hardware 430-2 and cellular front end 434, function similarly to the detailed components of RF unit 450, but can instead be used for cellular backhaul communications with primary AP 110.

As previously detailed, secondary AP 120-1 communicates directly with UE via a cellular communication protocol (e.g., 5G NR) and also has a cellular backhaul communication channel with primary AP 110. Separate hardware and/or spectrum may be used for each of these uses. For example, RF unit 450 may be used exclusively for communication with UE while RF unit 455 may be used exclusively for cellular backhaul. Spectrum may be segregated by use as detailed in relation to primary AP 110 of FIG. 3.

Baseband processing system 414 may be a system on a chip (SOC) or multi-chip system that serves to perform cellular-specific computing. Baseband processing system 414 can perform baseband processing for RF units 450 and RF unit 455, which is represented as baseband processing systems 414-1 and 414-2. Baseband processing system 414 can include a lower layer processing unit that utilizes special-purpose hardware acceleration (e.g., a purpose-designed ASIC). Baseband processing system 414 can also include an upper level processing unit that is implemented using one or more general purpose processors. Baseband processing system 414 can perform execution of algorithms that include channel estimation, modulation, demodulation, and forward error correction (FEC). Accordingly, baseband processing system 414 can translate data into and out of a digital form specific for transmission on a 5G NR network.

RF units 450 and 455 can use different frequency bands for cellular communications. Some frequency bands are frequency division duplex (FDD), meaning that different frequencies are used for uplink and downlink communications. Conversely some frequency bands, such as n77 and the Citizens Broadband Radio Service (CBRS) band (3550 MHz to 3700 MHz), can use a time division duplex (TDD) arrangement. As such, the same frequencies are used for uplink and downlink communications at different times. Depending on how bandwidth is allocated, when 100 MHz is used, along with a modulation of 256 QAM and 30 KHz subcarrier spacing (SCS), 1.6 Gbps throughput can be realized with a 70% downlink bias (DDDDDDDSUU). If 80 MHz of bandwidth is used and other parameters are maintained, 1.3 Gbps can be realized. If a 60% downlink bias (DDDSU) is used, 1.4 Gbps may be realized with a 100 MHz bandwidth. If 80 MHz of bandwidth is used and other parameters are maintained, 1.1 Gbps throughput can be realized.

Optionally present in secondary AP 120-1 is WLAN unit 460. WLAN unit 460 can include WLAN T/R hardware 421 and WLAN front end 422. WLAN front end 422 can include multiple amplifiers, mixers, and antennas used to transmit and receive RF. WLAN front end 422 can be used for a multiple input, multiple output (MIMO) arrangement allowing for multiple transmissions or multiple receptions of RF simultaneously. For example, WLAN front end 422 can include four antennas and associated hardware. WLAN T/R hardware 421 can servs to convert between digital data and RF.

WLAN system 420 can serve to encode and decode communications into an appropriate format for WLAN communications. For example, WLAN system 420 can utilize a standard from the IEEE 802.11 family of standards. As an example, WiFi may be used for WLAN communications.

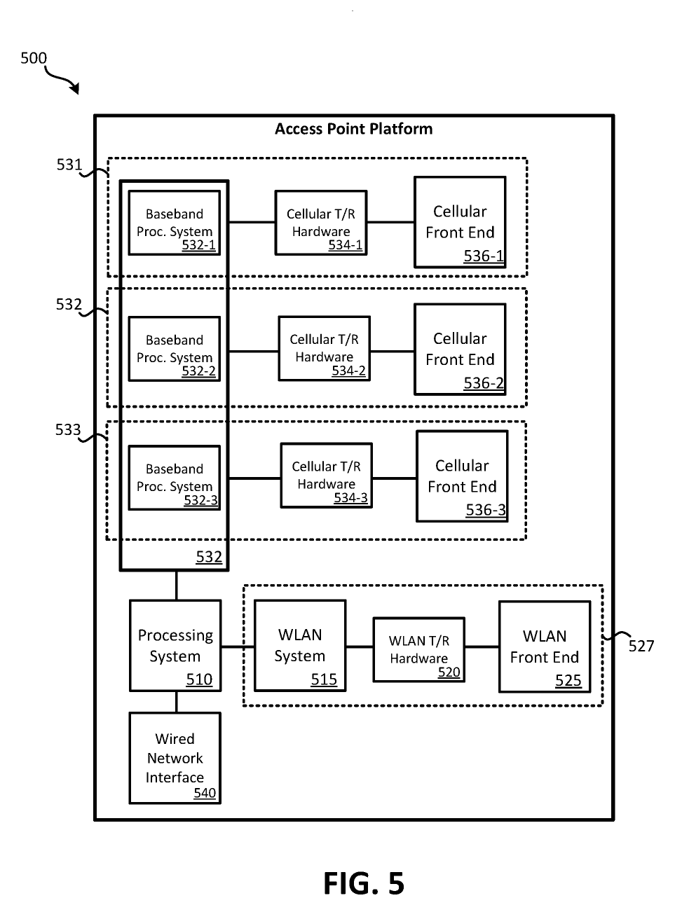

FIG. 5 illustrates a block diagram of an AP platform 500 from which primary APs and secondary APs can be created. Having a common platform allows for whichever type of AP is needed to be easily constructed with minimal hardware changes. AP platform 500 can include processing system 510, WLAN system 515; WLAN T/R hardware 520; WLAN front end 525; and cellular system 530, which can include baseband processing system 532; cellular T/R hardware 534; and cellular front ends 536.

Various slots may be present, such as to each receive M.2 form factor circuit boards. Circuit boards can be removed and installed to create either a primary AP or a secondary AP, optionally with WLAN capabilities. Alternatively, all illustrated hardware may be present, but one or more component groups may be disabled depending on whether a primary or secondary AP (with or without WLAN capabilities) is to be created. Wired network interface 540 may be present and can function as detailed in relation to wired network interface 330. Wired network interface 540 would remain unused on secondary APs.

As illustrated, three chains of cellular network components are present: cellular chain 531, cellular chain 532, and cellular chain 533. To create a primary AP, cellular T/R hardware 534-3 and cellular front end 536-3 of cellular chain 533 may be removed or not installed. Baseband processing system 532-3 may either be not installed or, if part of a SOC that performs the baseband processing of systems 532-1 and 532-2, Baseband processing system 532-3 may be deactivated or the SOC may not be programmed to perform such functionality. In such embodiments of a primary AP, cellular chain 532 can provide gNodeB services to UE and cellular chain 531 provides backhaul services to one or more secondary APs.

To create a secondary AP, cellular T/R hardware 534-1 and cellular front end 536-1 of cellular chain 531 may be removed or not installed (with cellular T/R hardware 534-3 and cellular front end 536-3 installed). Baseband processing system 532-1 may either be not installed or, if part of a SOC that performs the baseband processing of systems 532-2 and 532-3, Baseband processing system 532-1 may be deactivated or the SOC may not be programmed to perform such functionality. In such embodiments of a secondary AP, cellular chain 532 can provide gNodeB services to UE and cellular chain 533 provides backhaul services to the primary AP.

To create a primary AP for a relatively small environment in which no secondary APs are needed, cellular chain 531 and cellular chain 533 may be removed or not installed. Baseband processing systems 532-1 and 532-3 may either be not installed or, if part of a SOC that performs the baseband processing of systems 532-2, baseband processing systems 532-1 and 532-3 may be deactivated or the SOC may not be programmed to perform such functionality. In such embodiments of a primary AP, cellular chain 532 can provide gNodeB services to UE.

WLAN module 527 may be installed or installed in any of the described embodiments of platform 500 depending on whether wireless local area network communication is going to be supported in addition to cellular communications. In some arrangements, only some APs may provide WLAN services.

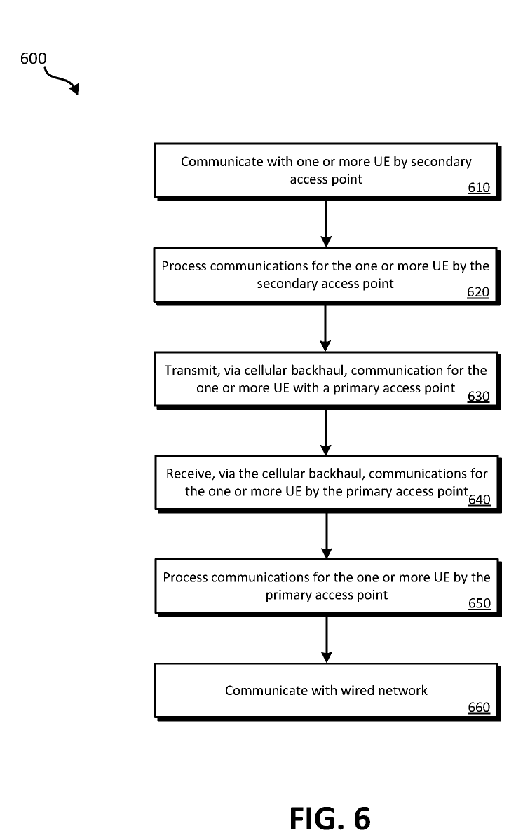

Various methods may be performed using the systems detailed in relation to FIGS. 1-5. FIG. 6 illustrates an embodiment of a method 600 for performing backhaul between nodes using cellular communications. Method 600 can be performed using an embodiment of system 100 or system 200. Method 600 is focused on a UE accessing either the Internet or a cellular core network via a secondary access point. For example, the UE may be attempting to use a cloud-based service, attempting to place a phone call, attempting to send an email or text message, etc.

At block 610, a secondary AP communicates wirelessly with one or more UE. The communications can be via a cellular communication protocol (e.g., 5G NR), a WLAN communication protocol (e.g., WiFi), or both. The frequency bands used for communication vary by whether the protocol is for cellular or WLAN. As part of block 610, data is received by the secondary access point that is to be routed to network 140 for delivery to a computer system on Internet 160 or to cellular network core 150.

At block 620, communications received by the secondary AP are processed. This processing can include prioritization, such as prioritization according to a prioritization scheme. For cellular communications, such prioritization can be performed in accordance with the QoS parameters of cellular slice to which the UE is assigned. For WLAN communications, prioritization can also be performed among other WLAN communications and cellular communications. In some embodiments, cellular communications are prioritized over all WLAN communications. As part of block 630, processing can include performing data conversion. From the perspective of UE, the secondary AP serves as the gNodeB; however, from the perspective of the secondary AP, the primary AP serves as the gNodeB.

At block 630, via a cellular backhaul communication link, the communication received at block 610 is transmitted to the primary AP. If the communications of block 610 were cellular, the cellular backhaul communications may use different spectrum than the communications of block 610. If the communications of block 610 were via a WLAN protocol, the communications are converted to cellular and use different spectrum for the cellular backhaul communications. For example, a frequency band may be locally reserved for backhaul usage to help ensure QoS parameters for the secondary AP. Communications for many UE may be transmitted via the cellular backhaul communication link to the primary AP.

At block 640, via the cellular backhaul communication link, communications are received by the primary AP from the secondary AP. These communications can be for the UE of block 610 and possibly additional UE. Other backhaul communications for other UE may also be received from other secondary APs by the primary AP as part of block 640.

At block 650, communications received by the primary AP are processed locally by the primary AP. This processing can include prioritization, such as prioritization according to a prioritization scheme (which can be in addition to the prioritization that occurred at the secondary AP, for example, prioritization by the primary AP can also factor in other communications occurring directly between the primary AP and UE. For cellular communications, such prioritization can be performed in accordance with the QoS parameters of cellular slice to which the UE is assigned. For WLAN communications, prioritization can also be performed among other WLAN communications and cellular communications. In some embodiments, cellular communications are prioritized over all WLAN communications. As part of block 650, processing can include performing data conversion.

At block 660, the primary AP communicates with the wired network, such as to transmit communications initially received at block 610 and receive communications to be routed to various UE at the secondary AP, the primary AP, or both. Cellular network-specific communications, such as the placing of a phone call or transmitting a text message, can occur via a cellular network core, which is accessible via network 140.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A cellular network communication system, comprising:
a primary access point, comprising:
a wired high speed network connection;
a cellular interface through which a cellular backhaul communication channel is established between a secondary access point and the primary access point using a cellular network communication protocol; and
the secondary access point, comprising:
a second cellular interface through which one or more user equipment (UE) communicate, via the cellular network communication protocol, with the secondary access point and access the wired high speed network connection via the cellular backhaul communication channel; and
a third cellular interface through which the cellular backhaul communication channel is established with the primary access point using the cellular network communication protocol.

2. The cellular network communication system of claim 1, wherein the primary access point further comprises a fourth cellular interface with which one or more additional UE communicate, via the cellular network communication protocol, with the primary access point and access the wired high speed network connection.

3. The cellular network communication system of claim 1,. the cellular network communication protocol is 5G New Radio (NR).

4. The cellular network communication system of claim 3, wherein the secondary access point provides gNodeB functionality to the one or more UE accessing the secondary access point using 5G NR.

5. The cellular network communication system of claim 4, wherein the secondary access point uses integrated access backhaul to communicate with the primary access point.

6. The cellular network communication system of claim 5, wherein the secondary access point prioritizes communications of the UE based upon slices to which the UE are assigned.

7. The cellular network communication system of claim 1, wherein:
a first frequency band is used by the second cellular interface to communicate with UE and
a second frequency band, wholly distinct from the first frequency band, is used by the cellular interface and the third cellular interface for backhaul communications between the secondary access point and the primary access point.

8. The cellular network communication system of claim 7, wherein the secondary access point further comprises a WiFi interface through which UE can communicate, via a WiFi communication protocol, with the secondary access point and access the Internet via the cellular backhaul communication channel.

9. The cellular network communication system of claim 8, wherein communications received from the one or more UE via the WiFi interface of the secondary access point are translated by the secondary access point for communication over the cellular backhaul communication channel with the primary access point.

10. The cellular network communication system of claim 9, wherein communications received from the one or more UE via the WiFi interface of the secondary access point are interspersed with communications received from one or more additional UE via the third cellular interface through the cellular network communication protocol according to a defined prioritization scheme.

11. The cellular network communication system of claim 1, further comprising:
a second secondary access point, comprising:
a fifth cellular interface through which one or more additional UE can communicate, via the cellular network communication protocol, with the second secondary access point and access the Internet via the cellular backhaul communication channel; and
a sixth cellular interface through which the cellular backhaul communication channel is established with the primary access point using the cellular network communication protocol.

12. The cellular network communication system of claim 11, wherein accessing the Internet via the cellular backhaul communication channel comprises performing voice over IP (VoIP) communications via the Internet.

13. The cellular network communication system of claim 11, wherein the secondary access point and the second secondary access point each have no wired connection with any other access point.

14. The cellular network communication system of claim 1, wherein each of the cellular interface, the second cellular interface, and the third cellular interface use a multiple-input multiple-output (MIMO) communication arrangement.

15. A method for using a cellular network communication system, the method comprising:
receiving, by a secondary access point, first data from user equipment (UE) using cellular communications, wherein:
the cellular network communication system comprises a primary access point through which a wired high speed network connection is accessed; and
the secondary access point uses a cellular backhaul communication channel established between the secondary access point and the primary access point using a cellular network communication protocol to access the wired high speed network connection;
transmitting, by the secondary access point, via the cellular backhaul communication channel, the first data received by the secondary access point from the UE;
receiving, by the primary access point, via the cellular backhaul communication channel, the first data from the secondary access point; and
transmitting, by the primary access point, via a wired network connection, the first data to a cellular network core.

16. The method for using a cellular network communication system of claim 15, further comprising:
receiving, by the secondary access point, second data from a second UE using wireless local area network (WLAN) communications;
transmitting, by the secondary access point, via the cellular backhaul communication channel, the second data received by the secondary access point from the second UE;
receiving, by the primary access point, via the cellular backhaul communication channel, the second data from the secondary access point; and
transmitting, by the primary access point, via the wired network connection, the second data to the Internet.

17. The method for using a cellular network communication system of claim 16, further comprising:
performing, by the secondary access point, prioritization among the first data received using the cellular communications and the second data received using the wireless local area network communications.

18. The method for using a cellular network communication system of claim 15, wherein a first frequency band is used by the secondary access point to communicate with the UE and a second frequency band, wholly distinct from the first frequency band, is used for cellular backhaul communications between the secondary access point and the primary access point.

19. The method for using a cellular network communication system of claim 17, further comprising:
performing, by the primary access point, prioritization among the first data received using the cellular communications, the second data received using the wireless local area network communications, and third data received directly by the primary access point from one or more additional UE.

20. The method for using a cellular network communication system of claim 16, wherein receiving, by the primary access point, via the cellular backhaul communication channel, the data from the secondary access point comprises the primary access point serving as a gNodeB for the secondary access point.
